(19) United States
(12) Patent Application Publication
(10) Pub. No.: US 2025/0035931 A1
(43) Pub. Date: Jan. 30, 2025

(54) VIRTUAL IMAGE DISPLAY DEVICE AND OPTICAL UNIT

(71) Applicant: SEIKO EPSON CORPORATION, Tokyo (JP)

(72) Inventors: Toshiaki MIYAO, CHINO-SHI (JP); Toshiyuki NOGUCHI, SHIOJIRI-SHI (JP); Takuya IKEDA, SHIOJIRI-SHI (JP)

(73) Assignee: SEIKO EPSON CORPORATION, Tokyo (JP)

(21) Appl. No.: 18/784,935

(22) Filed: Jul. 26, 2024

(30) Foreign Application Priority Data
Jul. 28, 2023 (JP) 2023-123132

(51) Int. Cl. G02B 27/01

(52) U.S. Cl. CPC G02B 27/0172; G02B 27/0176; G02B 2027/0178

(57) ABSTRACT

A virtual image display device includes an image element, a projection optical system configured to project an image formed on the image element, a case configured to house the image element and the projection optical system in a positioned state, and an optical appearance component on which image light emitted from the projection optical system is incident. The optical appearance component includes a first bonding surface and a second bonding surface which extend in mutually intersecting directions and are each bonded to the case, and the second bonding surface includes two portions provided at separated positions with the case interposed therebetween.

The present application is based on, and claims priority from JP Application Serial Number 2023-123132, filed Jul. 28, 2023, the disclosure of which is hereby incorporated by reference herein in its entirety.

### BACKGROUND

### 1. Technical Field

The present disclosure relates to a head-mounted virtual image display device and an optical unit that enable observation of a virtual image.

### 2. Related Art

A virtual image display device has been known in which an image element case housing an image display element and a lens barrel housing a projection lens are bonded to each other by a plate-shaped portion and a coupling portion while adjusting a relative position between the image display element and the projection lens (JP 2017-211674 A). In this virtual image display device, even when a variation occurs in an optical system due to a manufacturing error or the like of the projection lens, the above variation can be corrected at the time of positioning the projection lens and the image display element.

In the device of the background art described above, when the image element case and the lens barrel are bonded to each other using a photo-curable adhesive, an uncured region easily remains in the adhesive at a deep position in an interior. In addition, in surface bonding, although strength against external force in a surface direction is high, it is difficult to obtain strength against external force in a rotation direction such as peeling from an end portion.

### SUMMARY

A virtual image display device and an optical unit in an aspect of the present disclosure includes an image element, a projection optical system configured to project an image formed on the image element, a case configured to house the image element and the projection optical system in a positioned state, and an optical appearance component on which the image light emitted from the projection optical system is incident, wherein the optical appearance component includes a first bonding surface and a second bonding surface extending in mutually intersecting directions and each bonded to the case, and the second bonding surface includes two portions provided at separated positions with the case interposed therebetween.

### BRIEF DESCRIPTION OF THE DRAWINGS

FIG. 1 is an external perspective view for explaining a mounting state of a head-mounted display device.

FIG. 2 is a side cross-sectional view for explaining an optical system and the like included in a virtual image display device on one side.

FIG. 3 is a perspective view for explaining an optical unit and a support structure thereof.

FIG. 4 is a side cross-sectional view of a barrel, an optical member held by the barrel, and the like.

FIG. 5 is a rear view of a remaining portion as a result of removing a barrel cover.

FIG. 6 is a perspective view for explaining a structure of a see-through mirror.

FIG. 7 illustrates a front view and a plan view of the virtual image display device or the optical unit.

FIG. 8 is a partially enlarged side view for explaining fixing of the see-through mirror to a case.

FIG. 9 is a perspective view for explaining a see-through mirror in a second embodiment.

FIG. 10 is a rear side perspective view for explaining a structure of the see-through mirror.

FIG. 11 is a partially enlarged side view for explaining fixing of the see-through mirror to the case.

FIG. 12 illustrates a front view and a plan view for explaining a virtual image display device according to a second embodiment.

### DESCRIPTION OF EMBODIMENTS

### First Embodiment

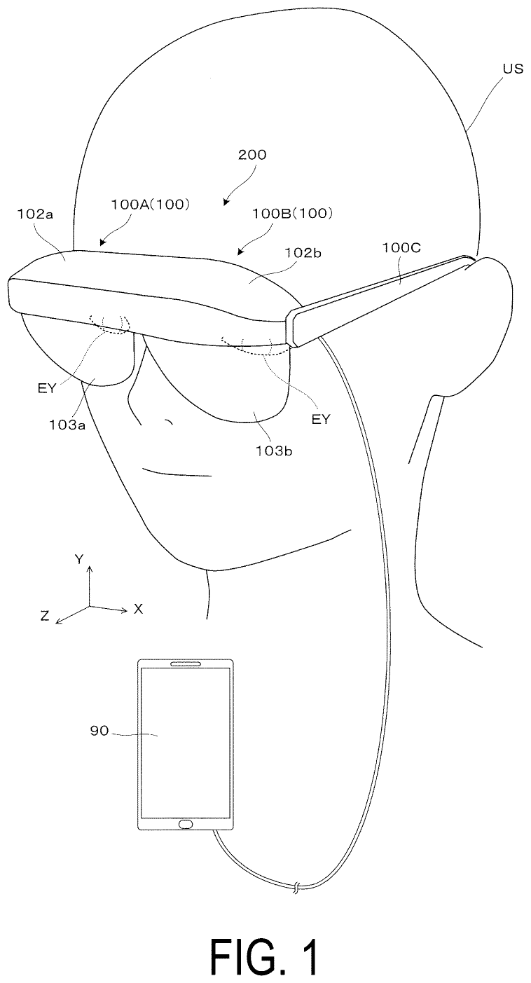

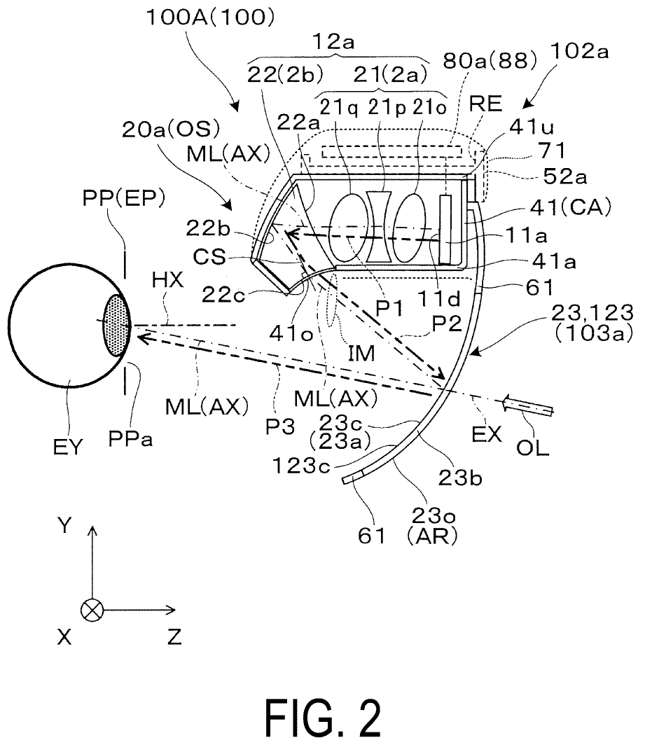

A first embodiment of a virtual image display device according to the present disclosure will be described below with reference to FIGS. 1, 2, and the like.

FIG. 1 is a diagram for explaining a mounted state of a head-mounted display device (hereinafter, also referred to as a head-mounted display or an “HMD”) 200, and the HMD 200 allows an observer or wearer US who is wearing the HMD 200 to recognize an image as a virtual image. In FIG. 1 and the like, X, Y, and Z indicate an orthogonal coordinate system, a +X direction corresponds to a lateral direction in which both eyes EY of the observer or wearer US wearing the HMD 200 are aligned, a +Y direction corresponds to an upward direction orthogonal to the lateral direction in which both the eyes EY are aligned for the wearer US, and a +Z direction corresponds to a forward or front direction for the wearer US. The +Y directions are parallel to a vertical axis or a vertical direction.

The HMD 200 includes a right-eye first virtual image display device 100A, a left-eye second virtual image display device 100B, a pair of temple type support devices 100C that support the display devices 100A and 100B, and a user terminal 90 as an information terminal. The first virtual image display device 100A alone functions as an HMD, and includes a first display driving unit 102a arranged at an upper portion thereof, and a first combiner 103a that has a spectacle lens shape and covers a front of an eye. The second virtual image display device 100B alone functions as an HMD similarly, and includes a second display driving unit 102b arranged at an upper portion thereof, and a second combiner 103b that has a spectacle lens shape and covers a front of an eye. The support devices 100C are mounting members mounted on a head of the wearer US, and support upper end sides of the pair of combiners 103a and 103b via the display driving units 102a and 102b that are integrated in appearance. The first virtual image display device 100A and the second virtual image display device 100B are optically identical or left-right inverted, and detailed description of the second virtual image display device 100B will be omitted.

FIG. 2 is a side cross-sectional view for explaining an internal structure of the first virtual image display device 100A. The first virtual image display device 100A includes a first image element 11a, a first display unit 20a, and a first circuit member 80a. The first display unit 20a is an imaging optical system that forms a virtual image and includes a projection lens 21, a prism mirror 22, and a see-through mirror 23. Of the first display unit 20a, the projection lens 21 and the prism mirror 22 function as a first projection optical system 12a where image light ML from the first image element 11a enters. The first display unit 20a includes the first projection optical system 12a and the see-through mirror 23 in an integrated state. The projection lens 21 constituting the first projection optical system 12a corresponds to a first optical member 2a disposed on a light emission side of the first image element 11a, and the prism mirror 22 corresponds to a second optical member 2b disposed on a light emission side of the first optical member 2a which is the projection lens 21. In addition, the first image element 11a, the projection lens 21, and the prism mirror 22 correspond to a portion of the first display driving unit 102a illustrated in FIG. 1, and the see-through mirror 23 corresponds to the first combiner 103a illustrated in FIG. 1. The projection lens 21 and the prism mirror 22 constituting the first projection optical system 12a are fixed together with the first image element 11a in a container-shaped barrel 41 in a mutually positioned state. The barrel 41 is a case CA that houses the first projection optical system 12a and the first image element 11a in a positioned state.

In the first virtual image display device 100A, the first image element 11a is an image-light generating device of a self-luminous type. The first image element 11a emits the image light ML to the first projection optical system 12a. The first image element 11a is housed and supported in the barrel 41 from behind. The first image element 11a is, for example, an organic electro-luminescence (EL) display, and forms a color still image or moving image on a two-dimensional display surface 11d. The first image element 11a performs display operation by being driven by a display control device 88 including the driving circuit member 80a. The first image element 11a is not limited to the organic EL display, and may be replaced with a display device using inorganic EL, an organic LED, an LED array, a laser array, a quantum dot light emission element, or the like. The first image element 11a is not limited to the image-light generating device of a self-luminous type, and it may be possible to employ a device including an LCD or other light modulating elements and illuminating the light modulating elements using a light source such as backlight to form an image. As for the first image element 11a, it may be possible to use liquid crystal on silicon (LCOS, LCoS is a registered trademark), a digital micro-mirror device, or the like, instead of the LCD. Note that an optical device obtained by excluding the driving circuit member 80a and the display control device 88 from the first virtual image display device 100A is also referred to as an optical unit 100.

The first display unit 20a includes two reflection surfaces, and an optical path is bent by the see-through mirror 23 and the prism mirror 22. The first display unit 20a is an off-axis optical system OS. The projection lens 21, the prism mirror 22, and the see-through mirror 23 are disposed to be non-axisymmetric. In this first display unit 20a, by bending an optical axis AX in an off-axis surface parallel to a YZ plane which is a reference surface, the optical elements 21, 22 and 23 are arrayed along the off-axis surface (that is, the reference surface). Specifically, in the off-axis surface parallel to the YZ plane and corresponding to a plane of paper, an optical path portion P1 from the projection lens 21 to a reflection surface 22b, an optical path portion P2 from the reflection surface 22b to the see-through mirror 23, and an optical path portion P3 from the see-through mirror 23 to a pupil position PP are arranged so as to be bent in a Z shape in two stages.

In the first display unit 20a, the optical path portion P1 from the projection lens 21 to the reflection surface 22b extends in a slightly obliquely upward direction or a direction nearly parallel to the Z direction toward a back side with respect to a viewpoint. The optical path portion P2 from the reflection surface 22b to the see-through mirror 23 extends obliquely downward toward a front side. With a horizontal plane direction (XZ plane) as a reference, an inclination of the optical path portion P2 is larger than an inclination of the optical path portion P1. The optical path portion P3 from the see-through mirror 23 to the pupil position PP extends slightly obliquely upward or in a direction nearly parallel to the Z direction toward the back side. In the illustrated example, a portion of the optical axis AX corresponding to the optical path portion P3 corresponds to about −10°, with a downward direction toward the +Z direction as negative. That is, a see-through mirror 23 reflects the image light ML with the optical axis AX or the optical path portion P3 directed upward by a predetermined angle, that is, upward by about 10°. As a result, an exit optical axis EX obtained by extending a portion of the optical axis AX that corresponds to the optical path portion P3 extends so as to be tilted downward by approximately 10° relative to a central axis HX parallel to the +Z direction at the front.

In the first display unit 20a, the projection lens 21 includes a first lens 210, a second lens 21p, and a third lens 21q. The projection lens 21 receives the image light ML emitted from the first image element 11a to cause the light to enter the prism mirror 22. The projection lens 21 collects the image light ML emitted from the first image element 11a to make it into a state close to a collimated light beam. Optical surfaces of the first lens 210, the second lens 21p, and the third lens 21q constituting the projection lens 21, that is, incident surfaces and emission surfaces of these lenses are free form surfaces or aspherical surfaces. The incident surfaces and the emission surface of the first lens 210, the second lens 21p, and the third lens 21q are each asymmetric with respect to a longitudinal direction parallel to the YZ plane and intersecting the optical axis AX with the optical axis AX interposed therebetween, and are each symmetric with respect to the lateral direction or the X direction with the optical axis AX interposed therebetween. The first lens 210, the second lens 21p, and the third lens 21q are made of, for example, resin, but may also be made of glass. An antireflection film can be formed at each of the optical surfaces of the first lens 210, the second lens 21p and the third lens 21q constituting the projection lens 21.

The prism mirror 22 is an optical member having a refractive reflection function that is a mixture of a mirror function and a lens function, and refracts and reflects the image light ML from the projection lens 21. The prism mirror 22 includes an incident surface 22a arranged on the light emission side of the first optical member 2a, the reflection surface 22b for bending the optical axis AX, and an emission surface 22c facing the reflection surface 22b and arranged in a direction symmetrical to the incident surface 22a. The prism mirror 22 emits the image light ML incident from the front side, at which the projection lens 21 is disposed, with the image light ML bent in a direction inclined downward with respect to a direction reverse to an incident direction (a direction of a light source as seen from the prism mirror 22). The incident surface 22a, the reflection surface 22b, and the emission surface 22c which are the optical surfaces constituting the prism mirror 22 are asymmetrical to the longitudinal direction parallel to the YZ plane and intersecting the optical axis AX with the optical axis AX interposed therebetween, and are symmetrical to the lateral direction or the X direction with the optical axis AX interposed therebetween. The optical surfaces of the prism mirror 22, that is, the incident surface 22a, the reflection surface 22b and the emission surface 22c are, for example, free form surfaces. The incident surface 22a, the reflection surface 22b and the emission surface 22c are not limited to the free form surfaces, and may be aspherical surfaces. The prism mirror 22 may be made of, for example, resin, but may also be formed of glass. The reflection surface 22b is not limited to one that reflects the image light ML by total reflection, and may be a reflection surface constituted by a metal film or a dielectric multilayer film. In this case, a reflection film formed of a single layer film or multilayer film formed of metal such as Al or Ag is formed above the reflection surface 22b by vapor deposition or the like, or a sheet-shaped reflection film formed of metal is affixed thereto. Although detailed illustration is omitted, an antireflection film can be formed above the incident surface 22a and the emission surface 22c.

The emission surface 22c of the prism mirror 22 is a concave surface as a whole, is a concave surface on the off-axis plane that is parallel to the YZ plane and through which the optical axis AX passes, that is, on the plane of paper, and is also a concave surface in a cross-section CS perpendicular to the YZ plane and passing through a center of the emission surface 22c. The emission surface 22c of the prism mirror 22 is exposed at an emission opening 410 of the barrel 41, thus by being formed as the concave surface, contact with an external object can be easily avoided and occurrence of damage can be suppressed.

The see-through mirror 23, that is, the first combiner 103a is a mirror having optical transparency in a visible wavelength region. The see-through mirror 23 is a curved plate-shaped optical appearance component 123 that functions as a concave surface mirror, and partially reflects the image light ML from the prism mirror 22, and partially transmits outside light OL. On the see-through mirror 23, the image light ML emitted from the projection optical system 12a is incident, and the see-through mirror 23 reflects the image light ML from the projection optical system 12a toward the pupil position PP. The see-through mirror 23 includes a partial reflection surface 23c and an outer surface 230. The see-through mirror 23 covers the pupil position PP at which the eye EY or the pupil is disposed, has a concave shape toward the pupil position PP, and has a convex shape toward the outside as a result. The pupil position PP or an opening PPa thereof is referred to as an eye point or an eye box, and corresponds to an emission pupil EP of the first display unit 20a including the see-through mirror 23. The see-through mirror 23, as the concave mirror having positive power, enables enlarged viewing of an intermediate image IM formed by the first image element 11a and re-imaged by the first projection optical system 12a.

The see-through mirror 23 has a structure in which a transmissive reflective film 23a as the concave partial reflection surface 23c is formed above a back surface of a base material 23b being a plate-shaped body having optical transparency. The partial reflection surface 23c or the transmissive reflective film 23a has asymmetry across the optical axis AX in the longitudinal direction that is parallel to the YZ plane and intersects the optical axis AX, and has symmetry across the optical axis AX in the lateral direction or the X direction. The partial reflection surface 23c of the see-through mirror 23 is, for example, a free form surface. The partial reflection surface 23c is not limited to the free form surface, and may be an aspherical surface.

The partial reflection surface 23c of the see-through mirror 23 transmits a part of light when the image light ML is reflected. Thus, because the outside light OL passes through the see-through mirror 23, see-through view of the outside is enabled, and a virtual image can be superimposed on an outside image. At this time, when the base material 23b has a thickness of equal to or less than approximately a few millimeters, a change in magnification of the outside image can be curbed to be small. A reflectance of the partial reflection surface 23c with respect to the image light ML and the outside light OL is set to from 10% to 50% in a range of an incident angle of the assumed image light ML from the viewpoint of ensuring a brightness of the image light ML and facilitating observation of the outside image by see-through. The base material 23b of the see-through mirror 23 is formed of, for example, resin, and may also be formed of glass. The base material 23b is formed of the same material as a support plate 61 that supports the base material 23b from the surrounding thereof, and has the same thickness as the support plate 61. The transmissive reflective film 23a is formed of, for example, a dielectric multilayer film configured of a plurality of dielectric layers having an adjusted film thickness. The transmissive reflective film 23a may be a single-layer film or a multilayer film of metal such as Al or Ag of which a film thickness has been adjusted. The transmissive reflective film 23a may be formed by laminating using deposition, for example, and may also be formed by affixing a sheet-shaped reflection film. An antireflection film AR is formed at the outer surface 230 of the base material 23b.

The antireflection film AR does not need to be directly formed above the base material 23b, and, for example, the base material 23b may be covered with a hard coat film, and the antireflection film AR or an antifouling coat may be formed thereabove. The transmissive reflective film 23a also does not need to be formed directly above the base material 23b, and, for example, the base material 23b may be covered with a hard coat film, and the transmissive reflective film 23a may be formed thereabove. The transmissive reflective film 23a may be covered with a protective film or an antifouling coat.

The optical path will be described. The image light ML from the first image element 11a enters the projection lens 21 and is emitted from the projection lens 21 in a substantially collimated state. The image light ML that has passed through the projection lens 21 is incident on the prism mirror 22, passes through the incident surface 22a while being refracted, is reflected by the reflection surface 22b with a high reflectance close to 100%, and is refracted again by the emission surface 22c. The image light ML from the prism mirror 22, after once forming the intermediate image IM, is incident on the see-through mirror 23 and is reflected by the partial reflection surface 23c with a reflectance of about 50% or less. The image light ML reflected by the see-through mirror 23 is incident on the pupil position PP at which the eye EY or pupil of the wearer US is placed. The outside light OL that has passed through the see-through mirror 23 and the support plate 61 therearound is also incident on the pupil position PP. In other words, the wearer US wearing the first virtual image display device 100A can observe a virtual image of the image light ML in a state where it is superimposed on an external image.

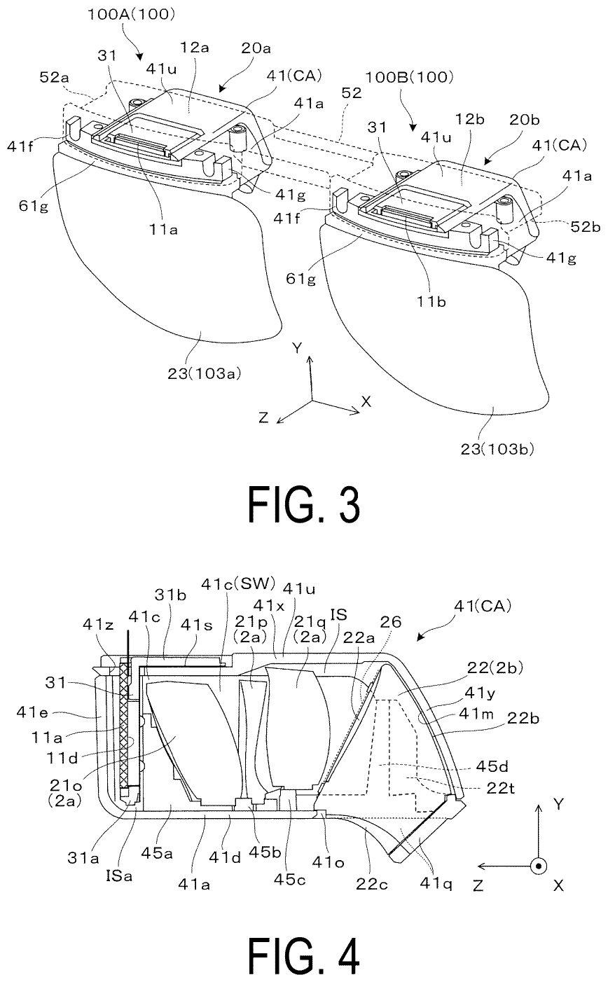

FIG. 3 is a perspective view for explaining the optical unit 100 and a support structure thereof in the virtual image display devices 100A and 100B. In the first virtual image display device 100A, the first display unit 20a is housed in the barrel 41, that is, the case CA, fixed to a portion 52a on the −X side of an elongated frame 52 indicated by a dotted line by using, for example, an adhesive, and is supported so as to be suspended from the frame 52 and disposed below the frame 52. In the second virtual image display device 100B, the second display unit 20b is housed in the barrel 41, that is, the case CA, fixed to a portion 52b on the +X side of the elongated frame 52 indicated by the dotted line by using, for example, an adhesive, and is supported so as to be suspended from the frame 52 and disposed below the frame 52. The frame 52 is made of a metal material such as, for example a magnesium alloy from the viewpoint of ensuring rigidity and lightweight properties. The frame 52 includes a recess RE for disposing the driving circuit member 80a on an upper side, and is covered from above and below by an exterior member 71 together with the barrel 41 (see FIG. 2).

The first display unit 20a has the first projection optical system 12a and the first combiner 103a in an integrated state, and the second display unit 20b has a second projection optical system 12b and the second combiner 103b in an integrated state. To the barrel 41 or the case CA housing the first projection optical system 12a, an upper end 61g of the first combiner 103a is fixed by adhesion or the like in a positioned state. The barrel 41 supporting the first combiner 103a includes a space for housing the first image element 11a in addition to the first projection optical system 12a, and supports the first image element 11a in a positioned state with respect to the projection lens 21 and the like illustrated in FIG. 2 and the like. To the barrel 41 or the case CA housing the second projection optical system 12b, the upper end 61g of the second combiner 103b is fixed to by adhesion or the like in a positioned state. The barrel 41 supporting the second combiner 103b includes a space for housing a second image element 11b in addition to the second projection optical system 12b, and supports the second image element 11b in a positioned state with respect to one similar to the projection lens 21 and the like illustrated in FIG. 2 and the like.

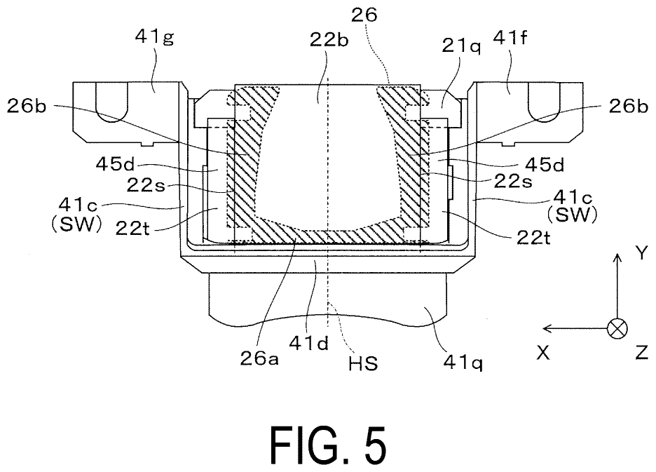

A structure of the barrel 41, that is, the case CA, will be described with reference to FIGS. 4 and 5. The barrel 41, that is, the case CA includes a barrel body 41a and a barrel cover 41u, houses the first optical member 2a and holds the second optical member 2b. The barrel body 41a and the barrel cover 41u are made of a resin material obtained by adding a black pigment to a polycarbonate resin to provide light-shielding properties. The barrel body 41a is a bathtub-shaped vessel with an open top, and includes the emission opening 410 at a part of a bottom. The barrel cover 41u is fixed so as to cover the barrel body 41a from above. The barrel body 41a includes two side plate members 41c, a bottom plate member 41d, a front plate member 41e and two protruding portions 41f and 41g. Among them, the two side plate members 41c are referred to as side walls SW. The two side plate members 41c extend substantially parallel to a reference plane HS in which the optical axis AX extends and are spaced apart from each other. The bottom plate member 41d extends substantially parallel to the XZ plane perpendicular to the reference plane HS in which the optical axis AX extends, and is provided with the emission opening 410 at a rear end thereof. In the bottom plate member 41d, a guard member 41q is provided behind and beside the emission opening 410, and covers a lower portion of a side surface 22s of the second optical member 2b (see FIG. 5). The front plate member 41e links a front end of the bottom plate member 41d and front ends of the two side plate members 41c. The two protruding portions 41f and 41g extend in the lateral direction so as to protrude outward from upper portions of the two side plate members 41c. That is, the barrel 41, that is, the case CA includes the pair of protruding portions 41f and 41g extending from the two side plate members 41c forming the side walls SW or the side surfaces.

At an inside of the side plate member 41c on one side (see FIG. 4), guide convex portions 45a, 45b, 45c and 45d each having steps, as protrusions for supporting the first lens 210, the second lens 21p and the third lens 21q constituting the first optical member 2a, and the prism mirror 22 of the second optical member 2b are formed. Note that although not illustrated, guide convex portions similar to the guide convex portions 45a, 45b, 45c, and 45d are also formed at an inner surface of the side plate member 41c on another side (see FIG. 5). The first lens 210 is bonded in a biased and positioned state by the two facing first guide convex portions 45a provided at the inner surfaces of the two side plate members 41c and is supported by the barrel body 41a. Similarly, the second lens 21p is bonded in a state of being positioned by the second guide convex portions 45b and supported by the barrel body 41a, the third lens 21q is bonded in a state of being positioned by the third guide convex portions 45c and supported by the barrel body 41a. The prism mirror 22 is bonded in a positioned state by the fourth guide convex portion 45d via a protrusion 22t provided at the side surface 22s of the prism mirror 22, and is supported by the barrel body 41a.

The barrel cover 41u is disposed on an opposite side of the bottom plate member 41d and covers an inside of the barrel body 41a to form a housing space IS. The barrel cover 41u includes a top plate 41x and a rear plate 41y. The top plate 41x extends parallel to the XZ plane, and the rear plate 41y is arranged to be inclined so as to cover an outside of the reflection surface 22b of the prism mirror 22 of the second optical member 2b. In the barrel cover 41u, a positioning holder pedestal 41s lowered by a predetermined height from a periphery is formed at the front +Z side, and an insertion opening 41z is formed in front of the holder pedestal 41s. The holder pedestal 41s provided at the barrel cover 41u faces a base plate 31b of a holder 31 for the first image element 11a. The base plate 31b extends horizontally along the holder pedestal 41s, and is fixed to the barrel 41 by an adhesive while covering a part or all of the insertion opening 41z. An inner surface 41m of the rear plate 41y is inclined with respect to the XZ plane and the XY plane, and extends along the reflection surface 22b of the prism mirror 22 to the vicinity of the reflection surface 22b.

In the barrel 41, a diaphragm plate member 26 is disposed between the first optical member 2a and the second optical member 2b. The diaphragm plate member 26 includes a central portion 26a and two side portions 26b (see FIG. 5). That is, the diaphragm plate member 26 has a shape in which an upper end is opened.

In the barrel 41, the first image element 11a supported by a support frame 31a extending vertically downward from the base plate 31b of the holder 31 is inserted into a space ISa facing the front plate member 41e from above through the insertion opening 41z and fixed in a positioned state.

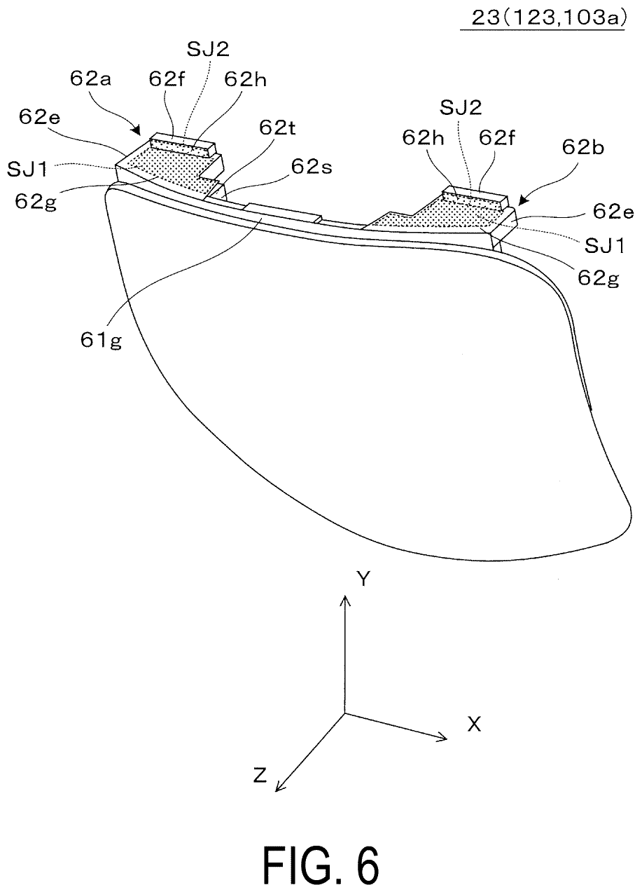

A structure for fixing the first combiner 103a, that is, the see-through mirror 23 to the case CA (see FIG. 4) will be described with reference to FIG. 6.

A pair of attachment portions 62a and 62b are formed at the upper end 61g of the see-through mirror 23 so as to protrude inward, that is, to the −Z side of the see-through mirror 23. Both the attachment portions 62a and 62b are spaced apart from each other in the lateral X direction. The attachment portion 62a on one side includes a plate-shaped member 62e parallel to the XZ plane extending horizontally, and a convex portion 62f protruding upward from the plate-shaped member 62e and extending in the lateral X direction. The attachment portion 62b on another side includes the plate-shaped member 62e parallel to the XZ plane extending horizontally, and the convex portion 62f protruding upward from the plate-shaped member 62e and extending in the lateral X direction. That is, the pair of attachment portions 62a and 62b include the pair of plate-shaped members 62e and the pair of protruding portions 62f. Each plate-shaped member 62e is provided with a first bonding surface SJ1 extending parallel to the perpendicular XZ plane as a partial region of an upper surface 62g, and each protruding portion 62f is provided with a second bonding surface SJ2 extending parallel to the vertical XY plane on a front surface 62h. The first bonding surface SJ1 and the second bonding surface SJ2 are used to fix the see-through mirror 23 to the pair of protruding portions 41f and 41g formed at the case CA. The first bonding surface SJ1 and the second bonding surface SJ2 extend in mutually intersecting directions. To be more specific, the first bonding surface SJ1 and the second bonding surface SJ2 are disposed in a state of being orthogonal to each other and adjacent to each other without being separated from each other.

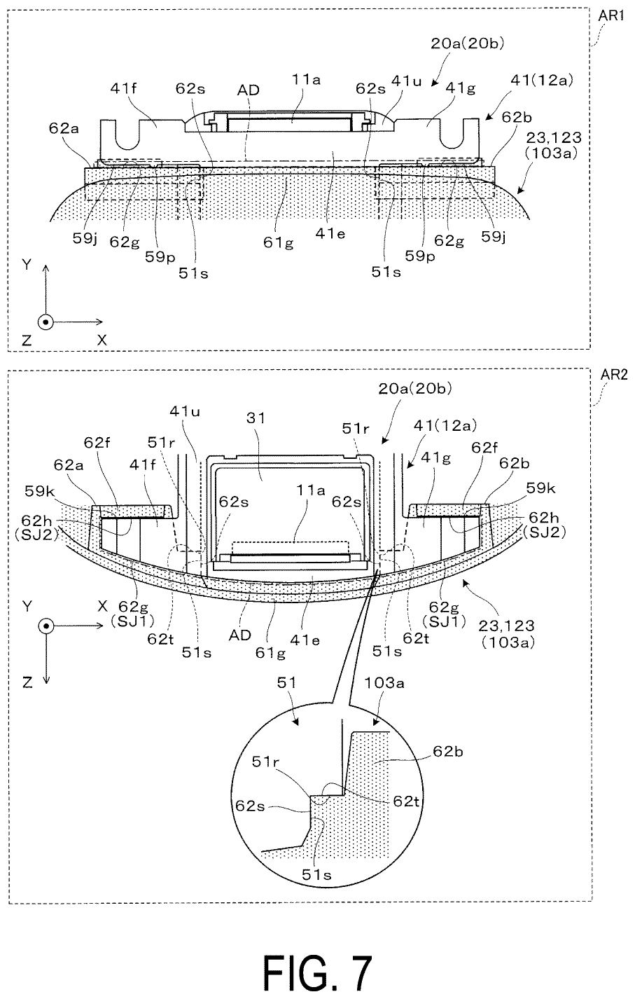

With reference to FIG. 7 and the like, fixing of the first combiner 103a, that is, the see-through mirror 23 to the case CA will be described. In FIG. 7, a region AR1 is a front view of the case CA and the see-through mirror 23, and a region AR2 is a plan view of the case CA and the see-through mirror 23.

A pair of facing inner surfaces 62s of the pair of attachment portions 62a and 62b provided at the see-through mirror 23 are fitted to a pair of lateral side surfaces 51s provided at boundaries between the front plate members 41e and the side plate members 41c of the case CA illustrated in FIG. 4 and narrowed in a stepped manner so as to sandwich the pair of lateral side surfaces 51s. Accordingly, the pair of inner surfaces 62s are fitted to the pair of lateral side surfaces 51s with predetermined play, and positioning of the see-through mirror 23 in the +X direction is performed so as to reduce inclination. A pair of stepped back surfaces 62t of the pair of attachment portions 62a and 62b abut on a pair of front surfaces 51r provided at the boundaries between the front plate members 41e and the side plate members 41c of the case CA and receding in a stepped manner. Accordingly, positioning of the see-through mirror 23 in the +Z direction is performed so as to reduce inclination. Further, a plurality of convex portions 59p protruding from bottom surfaces 59j of the pair of protruding portions 41f and 41g abut on a pair of the upper surfaces 62g of the pair of attachment portions 62a and 62b, and positioning in the +Y direction is performed. After the above-described positioning, that is, after the positioning of six axes, an adhesive AD is supplied from a periphery to a gap between the protruding portions 41f and 41g and the attachment portions 62a and 62b, and the supplied adhesive AD is cured by ultraviolet rays or the like, thereby completing the fixing of the see-through mirror 23 or the first combiner 103a to the case CA. That is, the see-through mirror 23 is integrated with the case CA, and the see-through mirror 23 is integrated with the first projection optical system 12a.

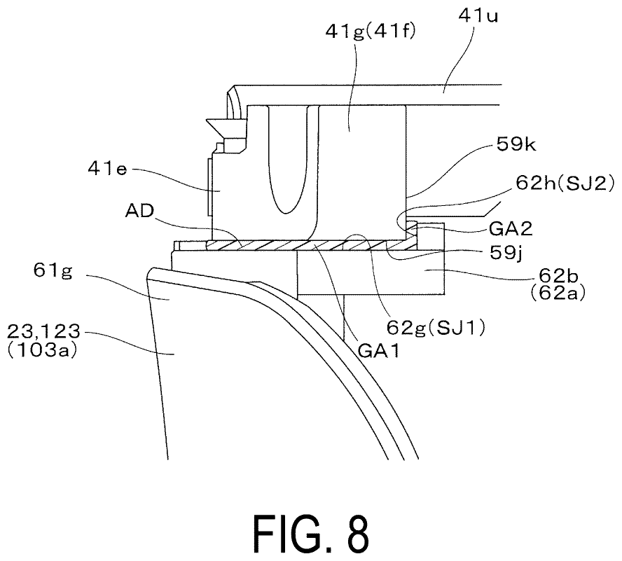

Referring to FIG. 8, the adhesive AD is filled and cured in a gap GA1 between the first bonding surface SJ1, which is the upper surface 62g provided at the attachment portion 62b of the see-through mirror 23, and the bottom surface 59j provided at the protruding portion 41g of the case CA, to join the attachment portion 62b and the protruding portion 41g. That is, the first bonding surface SJ1 is bonded to the bottom surface 59j of the protruding portion 41g. In addition, the adhesive AD is filled and cured in a gap GA2 between the second bonding surface SJ2, which is the front surface 62h provided at the attachment portion 62b, and a back surface 59k provided at the protruding portion 41g of the case CA, and the attachment portion 62b and the protruding portion 41g are joined by the cured adhesive AD. That is, the second bonding surface SJ2 is bonded to the back surface 59k of the protruding portion 41g. At this time, the second bonding surface SJ2 is separated from the case CA so as to avoid interference when positioning the see-through mirror 23. As illustrated in the drawing, the adhesive AD is filled not only in the gap GA1 between the first bonding surface SJ1 and the bottom surface 59j extending in the XZ directions but also in the gap GA2 between the second bonding surface SJ2 and the back surface 59k extending in the XY directions. Accordingly, as compared to a case of bonding only by the first bonding surface SJ1, the case CA is less likely to be damaged even when external force is variously applied to the see-through mirror 23. That is, a structure is obtained in which even when external force in a direction along the first bonding surface SJ1 or external force in a direction along the second bonding surface SJ2 (to be specific, rotational force around an X-axis) acts on joining portions between the case CA and the see-through mirror 23, peeling is less likely to occur against the external force, and it is easy to ensure strength of these joining portions, and these joining portions are less likely to be damaged.

The gap GA2 between the second bonding surface SJ2 provided at the attachment portion 62b of the see-through mirror 23 and the back surface 59k provided at the protruding portion 41g of the case CA can be utilized as play when positioning the see-through mirror 23 which is the optical appearance component 123 with respect to the case CA. Thus, the see-through mirror 23 can be fixed to the case CA with sufficient strength by the adhesive AD filled in the gap GA2 while ensuring positioning accuracy of the see-through mirror 23 with respect to the case CA.

Although the first bonding surface SJ1 and the second bonding surface SJ2 provided at the attachment portion 62b on one side of the see-through mirror 23 have been described above, the first bonding surface SJ1 and the second bonding surface SJ2 provided at the attachment portion 62a on another side are also joined to the protruding portion 41f of the case CA in the same manner as that illustrated in FIG. 8. As a result, the front plate member 41e and the like which are parts of the case CA are sandwiched between the first bonding surface SJ1 and the second bonding surface SJ2.

The first bonding surface SJ1 provided at the attachment portion 62a and the first bonding surface SJ1 provided at the attachment portion 62b are provided at positions separated from each other with the front plate member 41e and the like of the case CA interposed therebetween. Further, the second bonding surface SJ2 provided at the attachment portion 62a and the second bonding surface SJ2 provided at the attachment portion 62b are provided at positions separated from each other with the front plate member 41e and the like which are the parts of the case CA interposed therebetween. As described above, by providing the pair of second bonding surfaces SJ2 at the positions separated from each other with the case CA interposed therebetween, strength of a joining portion corresponding to the second bonding surface SJ2 can be increased also around a Z-axis and a Y-axis, and attachment accuracy and attachment strength of the see-through mirror 23 to the case CA can be increased.

In the see-through mirror 23, the base material 23b is formed of a material having optical transparency, and it is relatively easy to cure the adhesive AD having photocurability (specifically, UV curability) with which the gaps GA1 and GA2 are filled.

The fixing of the first combiner 103a to the case CA is performed before the holders 31 for the image elements 11a and 11b are fixed to the case CA, for example. Conversely, when the fixing of the holder 31 precedes the fixing of the first combiner 103a, the positioning of the holder 31 is performed with respect to the first projection optical system 12a.

The virtual image display devices 100A and 100B according to the first embodiment described above include the image elements 11a and 11b, the projection optical systems 12a and 12b that project images formed on the image elements 11a and 11b, the cases CA that houses the image elements 11a and 11b, and the projection optical systems 12a and 12b in a positioned state, and the optical appearance components 123 on which the image light ML emitted from the projection optical systems 12a and 12b is incident, the optical appearance components 123 each includes the first bonding surfaces SJ1 and the second bonding surfaces SJ2 that extend in mutually intersecting directions and are each bonded to the case CA, and the second bonding surfaces SJ2 are provided at separated positions with the case CA interposed therebetween.

In the above description, in each of the virtual image display devices 100A and 100B, since the optical appearance component 123 includes the first bonding surface SJ1 and the second bonding surface SJ2 that extend in the mutually intersecting directions and are each bonded to the case CA, sufficient bonding strength can be secured not only against external force along the first bonding surface SJ1 but also against external force in the rotational direction applied to an end of the first bonding surface SJ1. In addition, since the second bonding surfaces SJ2 are provided at separated positions with the case CA interposed therebetween, assembling accuracy and assembling strength of the optical appearance component 123 can be enhanced.

### Second Embodiment

A virtual image display device according to a second embodiment will be described below. The virtual image display device according to the second embodiment is obtained by partially modifying the virtual image display device according to the first embodiment, and description of parts in common with those of the virtual image display device according to the first embodiment is omitted.

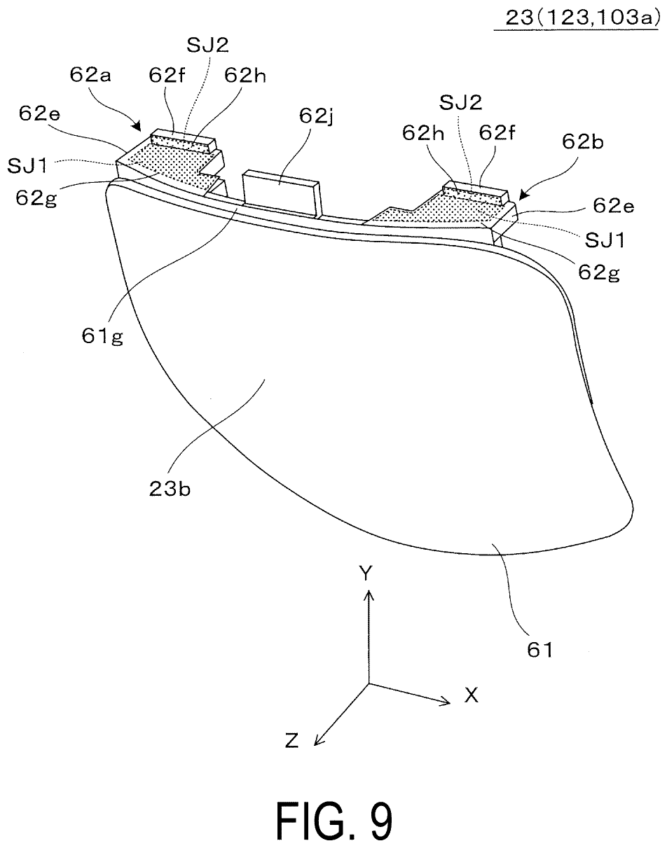

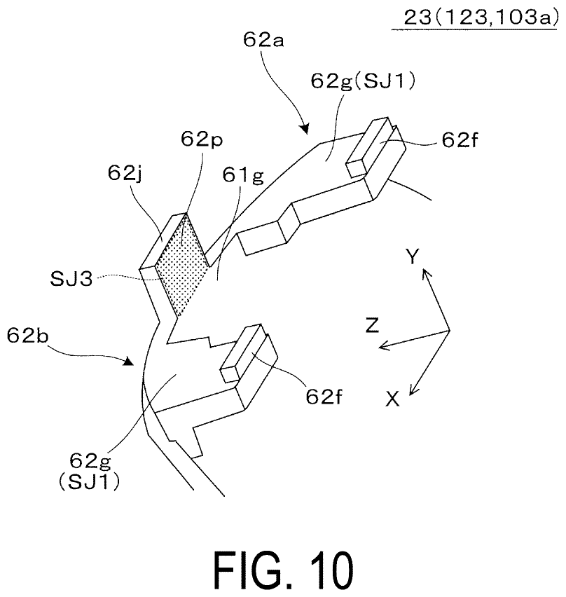

As illustrated in FIGS. 9 and 10, a rectangular protrusion 62j is formed at the upper end 61g of the see-through mirror 23, which is the optical appearance component 123, so as to protrude to an upper side, that is, to the +Y side of the see-through mirror 23. The protrusion 62j is a plate-shaped member parallel to the XY plane extending in the vertical direction, and a third bonding surface SJ3 extending parallel to the vertical XY plane is provided at a back surface 62p of the protrusion 62j. The third bonding surface SJ3 is added to the first bonding surface SJ1 and the second bonding surface SJ2, and is used for reinforcement to fix the see-through mirror 23 to the pair of protruding portions 41f and 41g (see FIG. 3) formed at the case CA.

The see-through mirror 23 is formed by injection molding, and the protrusion 62j is a gate mark where a molten resin is injected. The protrusion 62j is formed at a center of the upper end 61g of the see-through mirror 23. That is, the third bonding surface SJ3 provided at the protrusion 62j is disposed to face an intermediate position between the two second bonding surfaces SJ2. This is because when a molding gate which becomes the protrusion 62j is located at a center, a flow of the resin becomes symmetrical, formation of a flow mark at the base material 23b can be suppressed, and shrinkage at the time of molding can be made uniform. A lateral width of the protrusion 62j is about 1 cm, and a front-rear thickness of the protrusion 62j is equal to or greater than 1 mm, and desirably equal to or greater than about 1.5 mm. A thickness of the base material 23b or the support plate 61 which is a main body of the see-through mirror 23 is also equal to or larger than 1 mm, and desirably equal to or greater than about 1.5 mm from the viewpoint of molding. By setting the thickness of the base material 23b or the support plate 61 to be equal to or greater than 1 mm, the base material 23b or the support plate 61 can be accurately molded, and by setting the thickness of the protrusion 62j to be equal to or greater than 1 mm, strength of the protrusion 62j can be easily maintained, and a flow mark can be easily suppressed. A thickness of the attachment portion 62a, 62b, or the plate-shaped member 62e is also equal to or greater than 1 mm, and desirably equal to or greater than about 1.5 mm. The thickness of the attachment portion 62a, 62b, or the plate-shaped member 62e is equal to the thickness of the base material 23b or the support plate 61, or is relatively larger than the thickness of the base material 23b or the support plate 61. A thickness of the protrusion 62j in the Z direction is equal to the thickness of the base material 23b or the support plate 61, or is relatively smaller than the thickness of the base material 23b or the support plate 61.

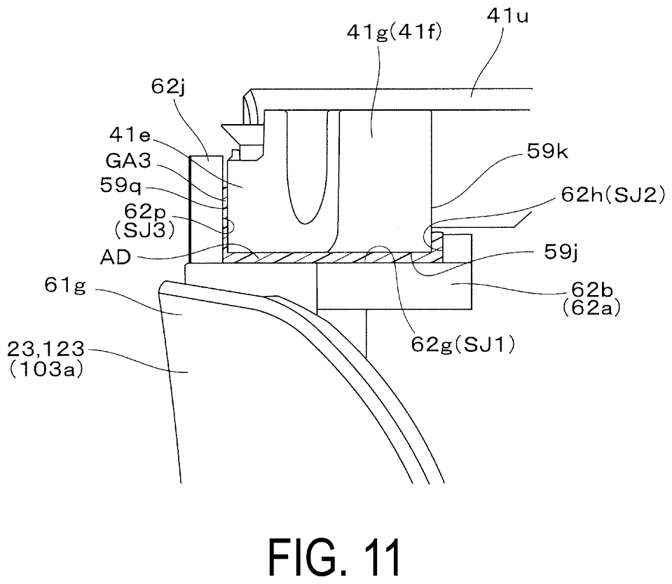

As illustrated in FIG. 11, the adhesive AD is filled and cured in the gap GA3 between the third bonding surface SJ3 which is the back surface 62p provided at the protrusion 62j and a front surface 59q provided at the front plate member 41e of the case CA, and the protrusion 62j and the front plate member 41e are joined by the cured adhesive AD.

In each of the virtual image display devices 100A and 100B according to the second embodiment described above, the optical appearance component 123 includes the third bonding surface SJ3 oriented in an opposite direction of the second bonding surface SJ2, and a part of the case CA is interposed between the second bonding surface SJ2 and the third bonding surface SJ3. In this case, the front plate member 41e and the protruding portions 41f and 41g which are parts of the case CA are sandwiched between the second bonding surface SJ2 and the third bonding surface SJ3, and three-point fixing is achieved by the second bonding surface SJ2 and the third bonding surface SJ3 extending parallel to the vertical Y direction, thus, fixing of the optical appearance component 123 to the case CA can be more stabilized and attachment accuracy can be enhanced. In particular, strength against external force such as rotational force around the X-axis can be improved from the viewpoint of sandwiching the front plate member 41e and the protruding portions 41f and 41g which are parts of the case CA between the second bonding surface SJ2 and the third bonding surface SJ3.

### Third Embodiment

A virtual image display device according to a third embodiment will be described below. The virtual image display device according to the third embodiment is obtained by partially modifying the virtual image display device according to the first embodiment, and description of parts in common with those of the virtual image display device according to the first embodiment is omitted.

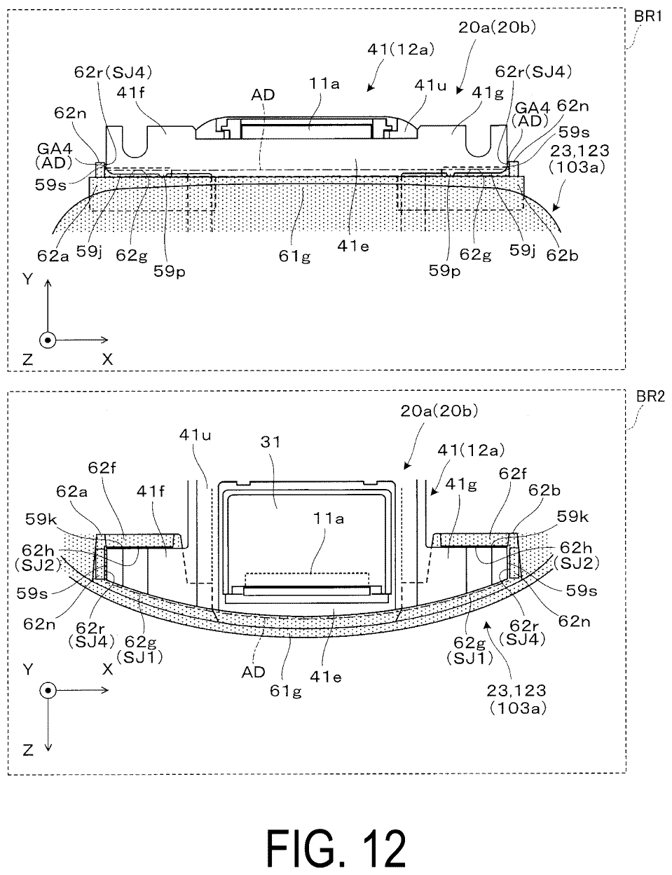

The virtual image display device 100A and 100B according to the third embodiment will be described with reference to FIG. 12. In FIG. 12, a region BR1 is a front view of the case CA and the see-through mirror 23, and a region BR2 is a plan view of the case CA and the see-through mirror 23.

Above the pair of attachment portions 62a and 62b formed at the upper end 61g of the see-through mirror 23, a pair of plate-shaped members 62n extending parallel to the vertical YZ plane are provided. Fourth bonding surfaces SJ4 extending parallel to the vertical YZ plane are provided at inner surfaces 62r of both the plate-shaped members 62n. The fourth bonding surface SJ4 is added to the first bonding surface SJ1 and the second bonding surface SJ2, and is used for reinforcement to fix the see-through mirror 23 to the pair of protruding portions 41f and 41g formed at the case CA.

The adhesive AD is filled and cured in gaps GA4 between the fourth bonding surfaces SJ4 which are the inner surfaces 62r provided at the pair of plate-shaped members 62n, and outer surfaces 59s of the pair of protruding portions 41f and 41g of the case CA, and the protrusion 62j is bonded to the pair of protruding portions 41f and 41g by the cured adhesive AD. With the pair of plate-shaped members 62n, strength against external force not only in the lateral X direction but also in the Y direction and the Z direction can be provided, and fixing strength of the see-through mirror 23 can be increased against external force for rotation about the horizontal Z-axis.

### Modification Examples and Others

Although the present disclosure has been described with reference to the above-described embodiments, the present disclosure is not limited to the above-described embodiments and can be implemented in various modes without departing from the spirit of the disclosure. For example, the following modifications are possible.

Although the HMD 200 includes the first virtual image display device 100A and the second virtual image display device 100B in the above description, the HMD 200 or the optical unit 100 may be configured such that the single first virtual image display device 100A or second virtual image display device 100B is supported in front of the eye by the support device 100C.

The first bonding surface SJ1 and the second bonding surface SJ2 are not limited to flat surfaces and may be curved surfaces, but, when the first bonding surface SJ1 and the second bonding surface SJ2 are curved surfaces, it is desirable that the back surface 59k or the bottom surface 59j facing the bonding surfaces are also curved surfaces having corresponding curvatures. Similarly, the third bonding surface SJ3 and the fourth bonding surface SJ4 may also be curved surfaces.

In the above-described embodiment, the bonding surfaces SJ1 include the two regions and are disposed at separated positions with the case CA interposed therebetween, but, the bonding surface SJ1 may include one region.

The bonding surfaces SJ1, SJ2, SJ3, and SJ4 are used for temporary positioning of the see-through mirror 23 with respect to the case CA in an auxiliary sense, but may be ones not used for such temporary positioning or may be used for precise positioning.

In the third embodiment illustrated in FIG. 12, the see-through mirror 23 may include the protrusion 62j illustrated in FIG. 9 or the third bonding surface SJ3 provided at the protrusion 62j.

The optical members 2a and 2b of the first projection optical system 12a are not limited to those illustrated in the figures, and for example, the number of the optical elements constituting the first optical member 2a and the shape of the optical surface can be appropriately changed in accordance with the purpose of use of the HMD 200 and the like.

The optical appearance component 123 is not limited to the see-through mirror 23 and may be a light-guiding plate or the like. Here, the light-guiding plate guides image light emitted from an image element to a position facing the pupil while reflecting the image light on inner surfaces, causes the image light to enter an inside from an incident surface provided at an end portion, or causes the image light to enter the inside via a diffraction element provided at a part of parallel flat plates constituting the light-guiding plate. The light-guiding plate as the optical appearance component 123 is a light-guiding plate in which, for example, a half mirror that is obliquely disposed is incorporated therein. The light-guiding plate as the optical appearance component 123 may be a light-guiding plate in which a diffraction element is provided at a front surface of a light extraction region or a light intake region, or a large number of inclined mirrors may be incorporated in the light-guiding plate in the light extraction region or the light intake region.

When the virtual image display devices 100A and 100B are each configured by a birdbath type optical system, a planar half mirror for light branching that is obliquely disposed, and a concave half mirror that covers an outside of the planar half mirror are disposed in front of the eye. In this case, the flat half mirror or the concave half mirror is the optical appearance component 123. Therefore, since the planar half mirror or the concave half mirror as the optical appearance component 123 is fixed to the case CA housing the projection optical system, as far as the planar half mirror or the concave half mirror includes the first bonding surfaces SJ1 and the second bonding surfaces SJ2 extending in intersecting directions and each bonded to the case CA, and the second bonding surfaces SJ2 are provided at separated positions with the case CA interposed therebetween, the bonding surfaces withstand stresses from various directions, and assembly accuracy and assembly strength of the planar half mirror or the concave half mirror can be enhanced.

The optical appearance component 123 is not limited to an optical element disposed on an outermost side of the HMD 200. That is, even when a shade for reducing light or a protective cover is provided in front of the see-through mirror 23 or the light-guiding plate which is the optical appearance component 123, the see-through mirror 23 or the like is the optical appearance component 123 from the viewpoint of an optical component exposed in front of the eye.

In the above description, the see-through mirror 23 is integrated with the first projection optical system 12a via the case CA, but the locations where the see-through mirror 23 is fixed to the case CA are not limited to the protruding portions 41f and 41g, and the see-through mirror 23 can be fixed to a main body of the case CA, and additionally, a receiving portion may be provided at any one of the optical elements constituting the first projection optical system 12a, and the see-through mirror 23 may be directly fixed to the receiving portion.

Although it has been assumed above that the HMD 200 is worn on the head and is used, the virtual image display devices 100A and 100B may also be used as a hand-held display that is not worn on the head and is to be looked into like binoculars. In other words, according to an aspect of the present disclosure, the head-mounted display also includes a hand-held display.

A virtual image display device according to a specific aspect includes an image element, a projection optical system configured to project an image formed on the image element, a case configured to house the image element and the projection optical system in a positioned state, and an optical appearance component on which image light emitted from the projection optical system is incident, wherein the optical appearance component includes a first bonding surface and a second bonding surface which extend in mutually intersecting directions and are each bonded to the case, and the second bonding surface includes two portions provided at separated positions with the case interposed therebetween. Here, the optical appearance component is fixed to the case using the first bonding surface and the second bonding surface to be integrated with the case. As a result, the optical appearance component is also integrated with the projection optical system or the like held by the case.

In the above-described head-mounted display device, since the optical appearance component includes the first bonding surface and the second bonding surface which extend in the mutually intersecting directions and are each bonded to the case, it is possible to secure sufficient bonding strength not only against external force along the first bonding surface but also against external force in a rotational direction applied to an end portion of the first bonding surface. In addition, since the second bonding surface includes two portions provided at separated positions with the case interposed therebetween, assembling accuracy and assembling strength of the optical appearance component can be enhanced.

In the virtual image display device according to a specific aspect, the second bonding surface is spaced apart from the case so as to avoid interference when positioning the optical appearance component.

In the virtual image display device according to a specific aspect, the first bonding surface and the second bonding surface are disposed in a state of being orthogonal and adjacent. In this case, the first bonding surface and the second bonding surface are disposed in an L shape. Accordingly, the first bonding surface and the second bonding surface can be collectively formed at one place, and the optical appearance component can be assembled in a space-saving manner.

In the virtual image display device according to a specific aspect, the case includes a pair of protruding portions extending from both side surfaces, the first bonding surface is bonded to a bottom surface of the pair of protruding portions, and the second bonding surface is bonded to a back surface of the pair of protruding portions. In this case, the optical appearance component can be assembled to the pair of protruding portions provided at the case in a stable state.

In the virtual image display device according to a specific aspect, the optical appearance component is a mirror having optical transparency.

In the virtual image display device according to a specific aspect, the optical appearance component is a plate-shaped see-through mirror having a concave partial reflection surface, and the first bonding surface and the second bonding surface are formed at an attachment portion formed at an upper end of the see-through mirror. In this case, the see-through mirror is fixed to the case at the attachment portion at the upper end thereof, and is supported by the case so as to be suspended from the case. Note that a thickness of the see-through mirror is equal to or greater than 1 mm (millimeter). When a base material of the see-through mirror is formed by injection molding, a thickness of a gate or gate mark for injection is equal to or less than a thickness of the base material or the attachment portion. Further, the thickness of the attachment portion is equal to or greater than the thickness of the base material.

In the virtual image display device according to a specific aspect, the see-through mirror is formed from a base material having optical transparency. When an adhesive having photocurability is used as an adhesive, since the base material of the see-through mirror has optical transparency, curing light easily reaches a bonding location, and the adhesive can be rapidly and reliably cured.

In the virtual image display device according to a specific aspect, the first bonding surface is formed at an upper surface of a plate-shaped member of the attachment portion, and the second bonding surface is formed at a front surface of a pair of convex portions protruding from the plate-shaped member of the attachment portion.

In the virtual image display device according to a specific aspect, the optical appearance component includes a third bonding surface oriented in an opposite direction of the second bonding surface, and a part of the case is interposed between the second bonding surface and the third bonding surface. In this case, since a part of the case is interposed between the second bonding surface and the third bonding surface, and three point fixing is achieved by the second bonding surface and the third bonding surface extending in parallel, it is possible to further stabilize the fixing of the optical appearance component to the case and to enhance attachment accuracy.

In the virtual image display device according to a specific aspect, the third bonding surface is a molding gate disposed to face an intermediate position between the two second bonding surfaces. In this case, the third bonding surface can be provided by diverting the gate.

An optical unit according to a specific aspect includes an image element, a projection optical system configured to project an image formed on the image element, a case configured to house the image element and the projection optical system in a positioned state, and an optical appearance component on which image light emitted from the projection optical system is incident, wherein the optical appearance component includes a first bonding surface and a second bonding surface which extend in mutually intersecting directions and are each bonded to the case, and the second bonding surface includes two portions provided at separated positions with the case interposed therebetween.

What is claimed is:

1. A virtual image display device, comprising:
an image element;
a projection optical system configured to project an image formed on the image element;
a case configured to house the image element and the projection optical system in a positioned state; and
an optical appearance component on which an image light emitted from the projection optical system is incident, wherein
the optical appearance component includes a first bonding surface and a second bonding surface extending in mutually intersecting directions and each bonded to the case, and the second bonding surface includes two portions provided at separated positions with the case interposed therebetween.

2. The virtual image display device according to claim 1, wherein
the second bonding surface is spaced apart from the case so as to avoid interference when positioning the optical appearance component.

3. The virtual image display device according to claim 1, wherein
the first bonding surface and the second bonding surface are disposed in a state of being orthogonal and adjacent.

4. The virtual image display device according to claim 3, wherein
the case includes a pair of protruding portions extending from both side surfaces,
the first bonding surface is bonded to a bottom surface of the pair of protruding portions, and
the second bonding surface is bonded to a back surface of the pair of protruding portions.

5. The virtual image display device according to claim 1, wherein
the optical appearance component is a mirror having optical transparency.

6. The virtual image display device according to claim 5, wherein
the optical appearance component is a plate-shaped see-through mirror having a concave partial reflection surface, and
the first bonding surface and the second bonding surface are formed at an attachment portion formed at an upper end of the see-through mirror.

7. The virtual image display device according to claim 6, wherein
the see-through mirror is formed from a base material having optical transparency.

8. The virtual image display device according to claim 6, wherein
the first bonding surface is formed at an upper surface of a plate-shaped member of the attachment portion, and
the second bonding surface is formed at a front surface of a pair of convex portions protruding from the plate-shaped member of the attachment portion.

9. The virtual image display device according to claim 1, wherein
the optical appearance component includes a third bonding surface oriented in an opposite direction of the second bonding surface, and
a part of the case is interposed between the second bonding surface and the third bonding surface.

10. The virtual image display device according to claim 1, wherein
the third bonding surface is a molding gate disposed to face an intermediate position between the two second bonding surfaces.

11. An optical unit, comprising:
an image element;
a projection optical system configured to project an image formed on the image element;
a case configured to house the image element and the projection optical system in a positioned state; and
an optical appearance component on which image light emitted from the projection optical system is incident, wherein
the optical appearance component includes a first bonding surface and a second bonding surface extending in mutually intersecting directions and each bonded to the case, and the second bonding surface includes two portions provided at separated positions with the case interposed therebetween.
